(19) United States
(12) Patent Application Publication
(10) Pub. No.: US 2024/0043194 A1
(43) Pub. Date: Feb. 8, 2024

(54) PACKAGING MATERIAL FOR HAIR DYE AND PACKAGE BAG PRODUCED THEREFROM

(71) Applicant: Cheng-Li Pao, Taichung City (TW)

(72) Inventor: Cheng-Li Pao, Taichung City (TW)

(21) Appl. No.: 17/879,811

(22) Filed: Aug. 3, 2022

(51) Int. Cl. B65D 75/42; B65D 75/26; B32B 7/02; B32B 27/08; B32B 27/36

(52) U.S. Cl. CPC B65D 75/42; B65D 75/26; B32B 7/02; B32B 27/08; B32B 27/36; B65D 2575/30; B32B 2250/03; B32B 2250/24; B32B 2255/10; B32B 2255/205; B32B 2307/732; B32B 2307/714; B32B 2553/00

(57) ABSTRACT

Provided is a packaging material for hair dye comprising: a protective layer, a light-shielding layer and a sealing layer; wherein the protective layer has an outer side and an inner side opposite to the outer side, and a printed layer is on the inner side; the light-shielding layer is disposed between the inner side and the sealing layer. Also provided is a package bag produced from the packaging material. The package bag has good corrosion resistance, so it can avoid leakage of hair dye accommodated therein, and the completeness of textual instructions or figures shown on the printed layer can be maintained, increasing the product value.

### BACKGROUND OF THE INVENTION

### Field of the Invention

The present invention relates to a packaging material and a package bag produced therefrom, and in particular to a packaging material for hair dye and a package bag mainly produced therefrom.

### 2. Description of Related Art

In general, hair dyes contain some corrosive ingredients. If the containers for hair dye do not have sufficient corrosion resistance, the containers may be corroded by the hair dye. Or, if the containers for hair dye are hit by a physical pressure such as an external impact, they may spring leaks, and then the hair dye would contact oxygen gas or water vapor in the air to make the hair dye deteriorated and fail; besides, the textual instructions or figures shown on the package may be destroyed to be hardly identified.

In the past, package bottles are used to accommodate the hair dye. However, the package bottles usually have a large capacity for accommodating dozens of usage amount. Once the package bottle is opened, it may be difficult to seal the package bottle completely, so that deterioration or failure of the hair dye may easily occur. Moreover, regardless that the textual instructions or figures are directly printed on the external wall of the package bottle, or are printed on a plastic film which is adhered to the external wall of the package bottle, it is very likely that the textual instructions or figures printed on or adhered to the external wall of the package bottle cannot be recognized because the package bottle is contaminated or stained by the hair dye whenever the hair dye is dispensed.

Hence, in order to solve the problem raised from the container, the applicant has begun to develop disposable package bags for hair dye in the early years. For example, TWI569958B provides a method of making an aluminum foil material for packaging hair dye. According to the method, a polyester film, an aluminum foil, a vacuum-electroplated polyester film and a polypropylene film are bonded together with an adhesive and then are hot-pressed by a hot press machine; after they stand for a predetermined time, the aluminum foil material for packaging hair dye is obtained. After successive production and research and development in recent years, although the above-mentioned method enables the disposable package bag for hair dye to have good corrosion resistance, it is still found that the package bags cannot solve the problem of damage to the textual instructions or figures when acidic or alkaline dyes are respectively accommodated in the package bags.

### SUMMARY OF THE INVENTION

To overcome the shortcomings, an objective of the present invention is to effectively reduce or even avoid the occurrence of contamination of textual instructions or figures on a package bag, so as to enhance the value of the product packed by the package bag.

Another objective of the present invention is to provide a packaging material with improved corrosion resistance against hair dye, so as to alleviate the problems of hair dye leak caused by the peel-off of the inner layer of the packaging material.

The invention is to provide a packaging material for hair dye comprising a protective layer, a light-shielding layer and a sealing layer. The protective layer has an outer side and an inner side opposite to the outer side, and the printed layer is laminated on the inner side of the protective layer; the light-shielding layer is disposed between the inner side of the protective layer and the sealing layer.

The sealing layer has a single-layer structure or a multilayer structure; when the sealing layer has the single-layer structure, a material of the sealing layer comprises a polyester, a polyamide, a polyethylene or a polypropylene; when the sealing layer has the multilayer structure, the multilayer structure has multiple sublayers, and the multiple sublayers are each independently made by a material selected from the group consisting of: a polyester, a polyamide (PA), a polyethylene (PE), a polypropylene (PP) and any combination thereof; and the materials of the sublayers are different from each other.

Through disposing the printed layer on the inner side of the protective layer, the textual instructions or figures shown in the printed layer are not easily damaged by abrasion, so the difficulty in identification will be avoided. Also, since the packaging material for hair dye of the present invention includes the light-shielding layer and the sealing layer made by the specific materials, the package produced therefrom has an improved corrosion resistance, and the textual instructions or figures shown in the printed layer will not be eroded or stained by the hair dye and they can maintain intact for a long time.

Specifically, a material of the protective layer comprises a polyester, but it is not limited thereto. Preferably, the polyester may be polyethylene terephthalate (PET).

Preferably, the protective layer may have an average thickness ranging from 6 micrometers (μm) to 24 μm, but it is not limited thereto. More preferably, the protective layer may have the average thickness ranging from 6 μm to 18 μm.

Specifically, the printed layer may be integrally laminated on the inner side of the protective layer by a conventional printing method. The ink to constitute the printed layer may be a water-based ink, an oil-based ink or a UV ink, but it is not limited thereto.

Preferably, the light-shielding layer may comprise a metal foil or a PET layer with a metal-plated layer thereon, but it is not limited thereto. Specifically, the light-shielding layer only needs to be opaque. Preferably, the metal foil may be an aluminum foil. Preferably, the PET layer with a metal-plated layer thereon may be a PET layer with an aluminum-plated layer thereon.

Preferably, the light-shielding layer may have an average thickness ranging from 4 μm to 15 μm; more preferably, the light-shielding layer may have the average thickness ranging from 4 μm to 13 μm.

In accordance with the present invention, the material of the sealing layer comprises a polyester, a PA, a PE or a PP. For example, the polyester may be PET; the PA may be Nylon 6 (PA6) or Nylon 66 (PA66). The PE may be a high density polyethylene (HDPE), a medium density polyethylene (MDPE), a low density polyethylene (LDPE) or a linear low density polyethylene (LLDPE).

In some embodiments, the sealing layer has the single-layer structure; that is, the packaging material for hair dye includes the protective layer, the printed layer, the light-shielding layer and the sealing layer from top to down. Preferably, the material of the sealing layer with the single-layer structure may comprise PE, but it is not limited thereto; more preferably, the material of the sealing layer with the single-layer structure may comprise LLDPE; therefore, the packaging material for hair dye can have better weather resistance and better corrosion resistance. In this embodiment, the sealing layer with the single-layer structure may have an average thickness ranging from 55 μm to 85 μm; preferably, the sealing layer with the single-layer structure may have an average thickness ranging from 60 μm to 80 μm.

In other embodiments, the sealing layer has the multilayer structure, and the multilayer structure has multiple sublayers. For example, the sealing layer may be a double-layer structure, which has a first sublayer and a second sublayer. The first sublayer mainly promotes the bonding between the sealing layer and the light-shielding layer, so as to enhance the overall stability of the packaging material for hair dye; besides, the second sublayer can provide a better anti-corrosion function. Accordingly, the packaging material for hair dye includes the protective layer, the printed layer, the light-shielding layer, the first sublayer of the sealing layer and the second sublayer of the sealing layer from top to down. Preferably, a material of the first sublayer may comprise the polyester or the PA; preferably, a material of the second sublayer may comprise the PE or the PP. In this embodiment, preferably, the sealing layer with the multilayer structure may have a total thickness ranging from 25 μm to 95 μm; more preferably, the sealing layer with the multilayer structure may have an average thickness ranging from 30 μm to 85 μm.

Preferably, the first sublayer may have an average thickness ranging from 5 μm to 25 μm; more preferably, the first sublayer may have the average thickness ranging from 10 μm to 20 μm. Preferably, the second sublayer may have an average thickness ranging from 20 μm to 70 μm; more preferably, the second sublayer may have the average thickness ranging from 20 μm to 65 μm.

Another objective of the present invention is to provide a package bag, which is produced from the packaging material for hair dye.

Specifically, the packaging material is subjected to a sealing process to define a storage space, which is configured to accommodate the hair dye.

In some cases, the storage space has one storage chamber, and the package bag with one storage chamber can be a package bag for one-part hair dye.

In other cases, the one storage chamber of the package bag may be heat pressed to form a partition element at the central portion of the one storage chamber; or, a spacer may be sandwiched as a partition element, so as to divide the one storage chamber into two storage chambers. Accordingly, the two storage chambers may be respectively filled with different hair dyes; that is, the package bag with two storage chambers can be a package bag for two-part hair dye, each part is accommodated in one storage chamber.

In some embodiments, the partition element may be parallel to bilateral sides of the package bag, and the two storage chambers each have a respective opening, the two openings being adjacent to each other (i.e. set left and right).

In other embodiments, the partition element may be sandwiched in the package bag, therefore, the two storage chambers are set front and rear.

### BRIEF DESCRIPTION OF THE DRAWINGS

FIG. 1A is a schematic stereogram diagram illustrating the packaging material for hair dye of Example 1.

FIG. 1B is a schematic breakdown view of the packaging material for hair dye of Example 1 shown in FIG. 1A.

FIG. 2 is a schematic stereogram diagram illustrating the packaging materials for hair dye of Examples 2 to 4.

FIG. 3 is a schematic stereogram diagram illustrating a package bag of one embodiment in accordance with the present disclosure.

FIG. 4 is a schematic stereogram diagram illustrating a package bag of another embodiment in accordance with the present disclosure.

FIG. 5 is a schematic stereogram diagram illustrating a package bag of still another embodiment in accordance with the present disclosure.

### DETAILED DESCRIPTION OF THE PREFERRED EMBODIMENTS

Hereinafter, one skilled in the arts can easily realize the advantages and effects of a packaging material for hair dye and a package bag produced therefrom in accordance with the present invention from the following examples. It should be understood that the descriptions proposed herein are just preferable examples only for the purpose of illustrations, not intended to limit the scope of the invention. Various modifications and variations could be made in order to practice or apply the present invention without departing from the spirit and scope of the invention.

### (Packaging Material for Hair Dye)

### Example 1: Packaging Material for Hair Dye a (LA)

First, one surface of a PET film with an average thickness of 12 μm was used as the inner side, and a printed layer was formed thereon by a general printing method. Next, said PET film laminated with the printed layer was sized on the surface of the printed layer and then was sent to an oven (40° C. to 70° C.). Subsequently, a 12 μm PET film with an aluminum-plated layer was adhered to the printed layer through a hot pressing wheel (40° C. to 60° C.) to form a first composite laminate; wherein the PET film with an aluminum-plated layer had an aluminum foil side and a PET side opposite to the aluminum foil side.

After that, the first composite laminate was cooled by a cooling wheel (15° C. to 25° C.) and then was left to stand for a day, so as to obtain a first semi-finished product. The first semi-finished product sequentially comprised the PET film, the printed layer and the PET film with an aluminum-plated layer, and the surface of the printed layer was joined to the aluminum foil side.

Further, the PET side of the PET film with an aluminum-plated layer of the first semi-finished product was sized and then was sent to an oven (40° C. to 70° C.). Subsequently, a LLDPE film with an average thickness of 70 μm was adhered to the PET side through a hot pressing wheel (40° C. to 60° C.) to form a second composite laminate; then, the second composite laminate was cooled by a cooling wheel (15° C. to 25° C.) and then was left to stand for 4 days (38° C. to 46° C.) in a storage room, and finally the packaging material for hair dye A was obtained. The packaging material for hair dye A sequentially comprised the PET film, the printed layer, the PET film with an aluminum-plated layer and the LLDPE; wherein the surface of the printed layer was joined to the aluminum foil side, and the PET side was joined to the LLDPE film.

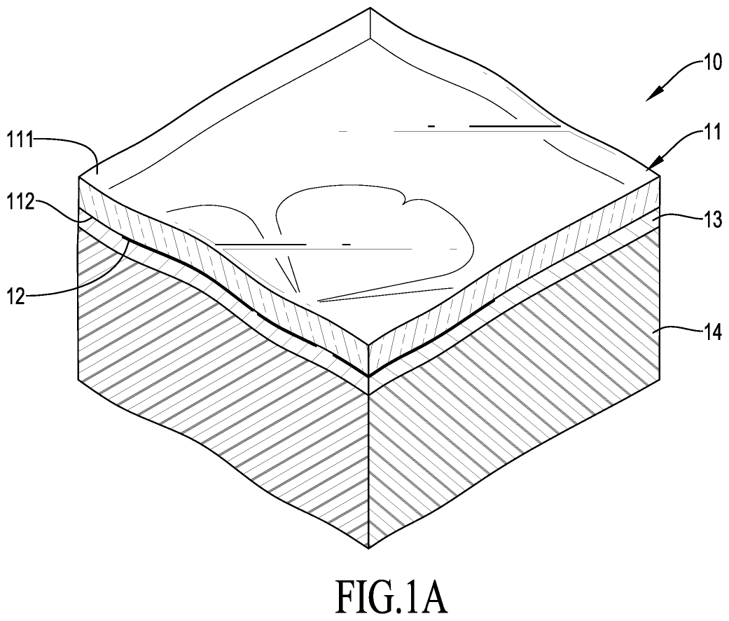

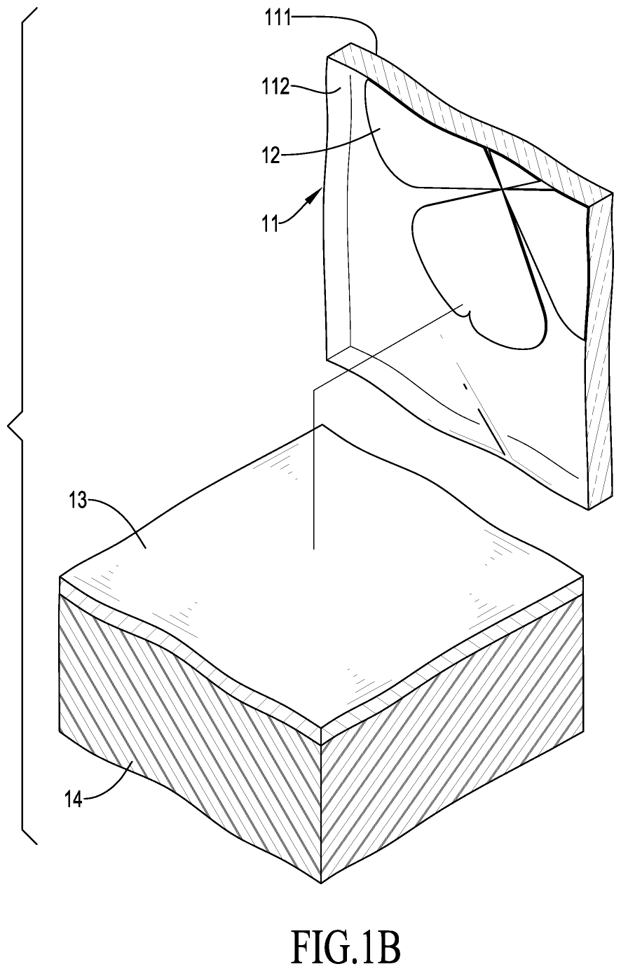

Please refer to FIG. 1A and FIG. 1B: the packaging material for hair dye 10 (i.e. the packaging material for hair dye A of Example 1) sequentially includes a protective layer 11 (i.e. said PET film), the printed layer 12, the light-shielding layer 13 (i.e. said PET film with an aluminum-plated layer) and the sealing layer 14 (i.e. said LLDPE film) from outside to inside; wherein the protective layer 11 has an outer side 111 and an inner side 112 opposite to the outer side 111, and the printed layer 12 is integrally laminated on the inner side 112 of the protective layer 11.

### Example 2: Packaging Material for Hair Dye B (LB)

First, one surface of a first PET film with an average thickness of 12 m was used as the inner side, and a printed layer was formed thereon by a general printing method. Next, said first PET film laminated with the printed layer was sized on the surface of the printed layer and then was sent to an oven (40° C. to 70° C.). Subsequently, an aluminum foil with an average thickness of 9 μm was adhered to the printed layer through a hot pressing wheel (40° C. to 60° C.) to form a first composite laminate; wherein the aluminum foil had a first side and a second side opposite to the first side.

After that, the first composite laminate was cooled by a cooling wheel (15° C. to 25° C.) and then was left to stand for a day, so as to obtain a first semi-finished product. The first semi-finished product sequentially comprised the first PET film, the printed layer and the aluminum foil, and the surface of the printed layer was joined to the first side of the aluminum foil.

On the other hand, one surface of a second PET film with an average thickness of 12 μm was sized and then was sent to an oven (40° C. to 70° C.). Subsequently, a cast polypropylene film (CPP film) with an average thickness of 40 μm was adhered to the sized surface of the second PET film through a hot pressing wheel (40° C. to 60° C.) to form a second composite laminate. After that, the second composite laminate was cooled by a cooling wheel (15° C. to 25° C.) and then was left to stand for a day, so as to obtain a second semi-finished product. The second semi-finished product comprised the second PET film and the CPP film.

Afterwards, the second side of the aluminum foil of the first semi-finished product was sized and then was sent to an oven (40° C. to 70° C.); subsequently, the second PET film of the second semi-finished product was adhered to the second side of the aluminum foil through a hot pressing wheel (40° C. to 60° C.) to form a third composite laminate; next, the third composite laminate was cooled by a cooling wheel (15° C. to 25° C.) and then was left to stand for 4 days (38° C. to 46° C.) in a storage room, and finally the packaging material for hair dye B was obtained. The packaging material for hair dye B sequentially comprised the first PET film, the printed layer, the aluminum foil, the second PET film and the CPP film.

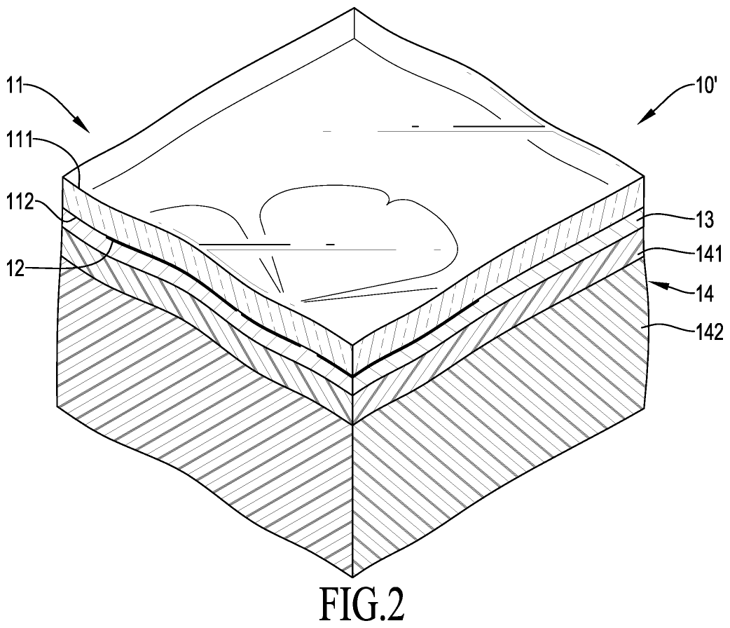

Please refer to FIG. 2: the packaging material for hair dye 10′ (i.e. the packaging material for hair dye B of Example 2) sequentially includes a protective layer 11 (i.e. said first PET film), the printed layer 12, the light-shielding layer 13 (i.e. said aluminum foil), the first sublayer 141 of the sealing layer 14 (i.e. said second PET film) and the second sublayer 142 of the sealing layer 14 (i.e. said CPP film) from outside to inside; wherein the protective layer 11 has an outer side 111 and an inner side 112 opposite to the outer side 111, and the printed layer 12 is integrally laminated on the inner side 112 of the protective layer 11.

### Example 3: Packaging Material for Hair Dye C (LC)

First, one surface of a first PET film with an average thickness of 12 m was used as the inner side, and a printed layer was formed thereon by a general printing method. Next, said first PET film laminated with the printed layer was sized on the surface of the printed layer and then was sent to an oven (40° C. to 70° C.). Subsequently, an aluminum foil with an average thickness of 9 μm was adhered to the printed layer through a hot pressing wheel (40° C. to 60° C.) to form a first composite laminate; wherein the aluminum foil had a first side and a second side opposite to the first side.

After that, the first composite laminate was cooled by a cooling wheel (15° C. to 25° C.) and then was left to stand for a day, so as to obtain a first semi-finished product. The first semi-finished product sequentially comprised the first PET film, the printed layer and the aluminum foil, and the surface of the printed layer was joined to the first side of the aluminum foil.

On the other hand, one surface of a second PET film with an average thickness of 12 μm was sized and then was sent to an oven (40° C. to 70° C.). Subsequently, a LLDPE film with an average thickness of 60 μm was adhered to the sized surface of the second PET film through a hot pressing wheel (40° C. to 60° C.) to form a second composite laminate. After that, the second composite laminate was cooled by a cooling wheel (15° C. to 25° C.) and then was left to stand for a day, so as to obtain a second semi-finished product. The second semi-finished product comprised the second PET film and the LLDPE film.

Afterwards, the second side of the aluminum foil of the first semi-finished product was sized and then was sent to an oven (40° C. to 70° C.); subsequently, the second PET film of the second semi-finished product was adhered to the second side of the aluminum foil through a hot pressing wheel (40° C. to 60° C.) to form a third composite laminate; next, the third composite laminate was cooled by a cooling wheel (15° C. to 25° C.) and then was left to stand for 4 days (38° C. to 46° C.) in a storage room, and finally the packaging material for hair dye C was obtained. The packaging material for hair dye C sequentially comprised the first PET film, the printed layer, the aluminum foil, the second PET film and the LLDPE film.

Please refer to FIG. 2: the packaging material for hair dye 10′ (i.e. the packaging material for hair dye C of Example 3) sequentially includes a protective layer 11 (i.e. said first PET film), the printed layer 12, the light-shielding layer 13 (i.e. said aluminum foil), the first sublayer 141 of the sealing layer 14 (i.e. said second PET film) and the second sublayer 142 of the sealing layer 14 (i.e. said LLDPE film) from outside to inside; wherein the protective layer 11 has an outer side 111 and an inner side 112 opposite to the outer side 111, and the printed layer 12 is integrally laminated on the inner side of the protective layer 11.

### Example 4: Packaging Material for Hair Dye D (LD)

First, one surface of a first PET film with an average thickness of 12 m was used as the inner side, and a printed layer was formed thereon by a general printing method. Next, said first PET film laminated with the printed layer was sized on the surface of the printed layer and then was sent to an oven (40° C. to 70° C.). Subsequently, an aluminum foil with an average thickness of 9 μm was adhered to the printed layer through a hot pressing wheel (40° C. to 60° C.) to form a first composite laminate; wherein the aluminum foil had a first side and a second side opposite to the first side.

After that, the first composite laminate was cooled by a cooling wheel (15° C. to 25° C.) and then was left to stand for a day, so as to obtain a first semi-finished product. The first semi-finished product sequentially comprised the first PET film, the printed layer and the aluminum foil, and the surface of the printed layer was joined to the first side of the aluminum foil.

On the other hand, one surface of a PA film with an average thickness of 15 μm was sized and then was sent to an oven (40° C. to 70° C.). Subsequently, a CPP film with an average thickness of 40 μm was adhered to the sized surface of the PA film through a hot pressing wheel (40° C. to 60° C.) to form a second composite laminate. After that, the second composite laminate was cooled by a cooling wheel (15° C. to 25° C.) and then was left to stand for a day, so as to obtain a second semi-finished product. The second semi-finished product comprised the PA film and the CPP film.

Afterwards, the second side of the aluminum foil of the first semi-finished product was sized and then was sent to an oven (40° C. to 70° C.); subsequently, the PA film of the second semi-finished product was adhered to the second side of the aluminum foil through a hot pressing wheel (40° C. to 60° C.) to form a third composite laminate; next, the third composite laminate was cooled by a cooling wheel (15° C. to 25° C.) and then was left to stand for 4 days (38° C. to 46° C.) in a storage room, and finally the packaging material for hair dye D was obtained. The packaging material for hair dye D sequentially comprised the first PET film, the printed layer, the aluminum foil, the PA film and the CPP film.

Please refer to FIG. 2: the packaging material for hair dye 10′ (i.e. the packaging material for hair dye D of Example 4) sequentially includes a protective layer 11 (i.e. said first PET film), the printed layer 12, the light-shielding layer 13 (i.e. said aluminum foil), the first sublayer 141 of the sealing layer 14 (i.e. said PA film) and the second sublayer 142 of the sealing layer 14 (i.e. said CPP film) from outside to inside; wherein the protective layer has an outer side 111 and an inner side 112 opposite to the outer side 111, and the printed layer 12 is integrally laminated on the inner side 112 of the protective layer 11.

### (Package Bag)

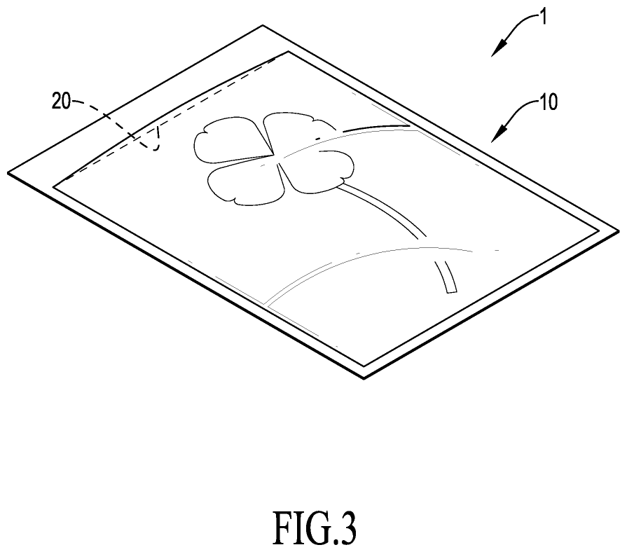

Please refer to FIG. 3: firstly, each of the packaging materials (e.g. the packaging material for hair dye 10 shown in FIG. 1A) was cut to a predetermined size, followed by folding the cut packaging material and respectively aligning the bilateral fold and overlapped side edges; subsequently, the bilateral overlapped sides and the bottom side of the folded packaging material were respectively sealed by instantaneously heating at a high temperature (100° C. to 150° C.) to define one storage chamber 20 with an opening on the top and three joined edges (i.e. two sealed side edges and one sealed bottom edge), and finally a package bag 1 with one opening was obtained.

Next, the disposable hair dye was filled into the package bag 1, and said opening was sealed to form a sealed package bag 1 for one-part hair dye, and the one storage chamber 20 accommodated the hair dye.

In other embodiments, the packaging material for hair dye 10′ in FIG. 2 may be used to replace the packaging material for hair dye 10 in FIG. 3.

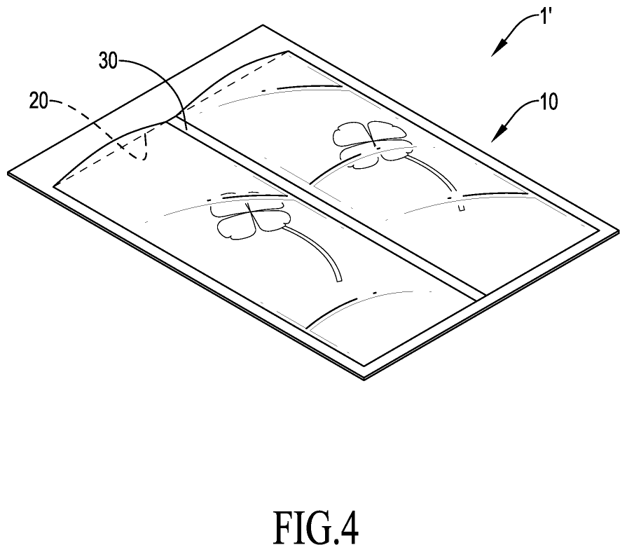

In addition, another embodiment also can refer to FIG. 4. Firstly, a packaging material (e.g. the packaging material for hair dye 10 shown in FIG. 1A) was cut to a predetermined size, followed by folding the cut packaging material and respectively aligning the bilateral fold and overlapped side edges; subsequently, the bilateral overlapped sides and the bottom side of the folded packaging material were respectively sealed by instantaneously heating at a high temperature (100° C. to 150° C.) to define one storage space with an opening on the top and three joined edges; next, a heating press step was carried out to form a partition element 30 at the central portion of the storage space along the direction perpendicular to the opening on the top, wherein the partition element 30 was parallel to the bilateral side edges of the package bag, thereby forming a package bag 1′ that had two storage chambers 20 spaced apart from each other, and the two storage chambers 20 each had a respective opening, the two openings being adjacent to each other (i.e. left and right). When two different kinds of hair dyes were respectively filled into the two storage chambers 20 of the package bag 1′, followed by sealing their openings, a sealed a package bag 1′ for two-part hair dye could be formed.

In other embodiments, the packaging material for hair dye 10′ in FIG. 2 may be used to replace the packaging material for hair dye 10 in FIG. 4.

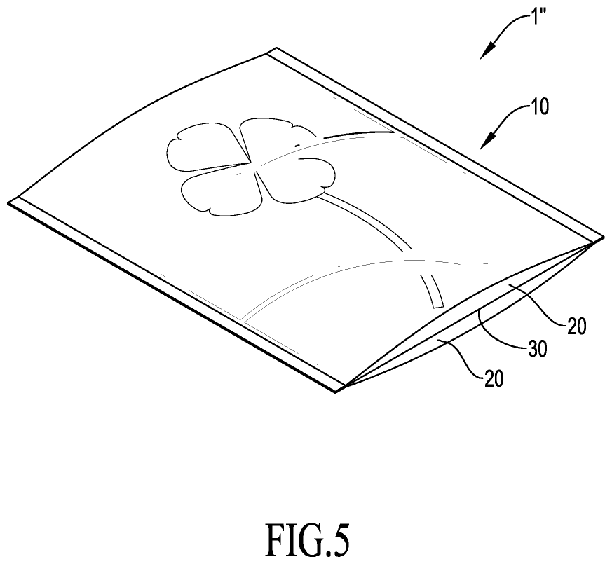

Or, still another embodiment also can refer to FIG. 5. Firstly, a packaging material (e.g. the packaging material for hair dye 10 shown in FIG. 1A) was cut to a predetermined size, followed by folding the cut packaging material and respectively aligning the bilateral overlapped sides; then, a spacer with the same size as the folded packaging material was sandwiched between the overlapped sides of the folded cut packaging material, and the bilateral side edges and the bottom edge of the spacer were sandwiched and aligned with the bilateral side edges and the bottom side of the folded packaging material to form a composite laminate. Wherein the material of the spacer could be the same as the aforementioned packaging material such as the packaging material for hair dye 10 shown in FIG. 1A. Subsequently, the two side edges and the bottom of the composite laminate were respectively sealed by instantaneously heating at a high temperature (100° C. to 150° C.) to define a bag body with two openings on the top and three sealed edges; each edge was constituted by three pieces of laminates (i.e. two pieces of the packaging material for hair dye and one piece of the spacer), so as to form a package bag 1″ with front and rear storage chambers 20; wherein the front and rear storage chambers 20 were separated by a partition element 30 made of the spacer. If two different kinds of hair dyes were respectively filled into the two storage chambers 20 of the package bag 1″, followed by sealing their openings, a sealed package bag 1″ for two-part hair dye could be formed.

In other embodiments, the packaging material for hair dye 10′ in FIG. 2 may be used to replace the packaging material for hair dye 10 in FIG. 5.

### (Characteristic Analysis for Packaging Materials for Hair Dye)

The packaging materials for hair dye A to D were sequentially analyzed by the test methods described below. In order to ensure the experimental significance of the characteristic analysis, the package bags produced therefrom were each respectively formed in the same manner from the corresponding packaging materials for hair dye, and the package bags were each analyzed by the same test method. Therefore, it can be understood that the main differences in characteristics between each group of the packaging materials for hair dye were caused by the differences in materials and thickness of the constitutive layers of the packaging materials for hair dye.

### Analysis 1: Stability Test at Room Temperature

The packaging material for hair dye A was used to form six samples of the package bag shown in FIG. 3 according to the above-described manufacturing method, and the six samples for test should have the same size. Similarly, each of the packaging materials for hair dyes B to D was also used to form six samples with the same size of the package bag shown in FIG. 3 according to the same manufacturing method.

In each group, three samples of the package bag were respectively used to fill with Hair Dye I, and the other three samples of the package bag were used to fill with Hair Dye II.

Hair Dye I: an alkaline dye containing 7 wt % of ammonia and pH value ranging from 9 to 11;

Hair Dye II: an acidic dye containing 12 wt % of hydrogen peroxide solution and pH value ranging from 2 to 4.

Each group of samples were placed in an environment keeping the temperature at 18° C. to 30° C. and a humidity of 40% to 50%, and the samples were opened by cutting after the specific days (i.e. 30 days, 60 days and 90 days). The Hair Dye I or the Hair Dye II filled therein was poured out and then the samples were respectively washed and followed by airing; finally, the samples were observed by naked eyes to ascertain whether the inner side of the sample (that is, the sealing layer of the packaging material for the hair dye) was peeled off or eroded, and observation results were recorded in Table 1.

When the peeling or erosion phenomenon of the inner side of the sample was not observed, it was determined as passing the stability test, which was indicated as “O” in Table 1; on the contrary, when the peeling or erosion phenomenon of the inner side of the sample was observed, it was determined that it did not pass the stability test, which was indicated as “X” in Table 1.

TABLE 1
No. of the packaging materials for hair dye of Examples
1 to 4, No. of the hair dyes, storage days at room
temperature and the results of the stability test

| No. of | | | | | | |
|---|---|---|---|---|---|---|
| Packaging | Hair Dye I | | | Hair Dye II | | |
| Material for | 30 | 60 | 90 | 30 | 60 | 90 |
| hair dye | Days | Days | Days | Days | Days | Days |
| LA | O | O | O | O | O | O |
| LB | O | O | O | O | O | O |
| LC | O | O | O | O | O | O |
| LD | O | O | O | O | O | O |

### Analysis 2: Stability Test in an Incubator

The packaging materials for hair dyes A to D were respectively used to form six samples with the same size of the package bag shown in FIG. 3 according to the above-mentioned manufacturing method in Analysis 1. In each group, three samples of the package bag were respectively used to fill with Hair Dye I, and the other three samples of the package bag were used to fill with Hair Dye II. The Hair Dye I and Hair Dye II had the same ingredients described in Analysis 1.

The stability test in the incubator at a higher temperature environment was to simulate the stability of the package bag stored for a longer time. In principle, the samples were stored in said incubator for 30 days to simulate the situation that they were stored at room temperature for 1 year. The samples were stored in said incubator for 60 days to simulate the situation that they were stored at room temperature for 2 years. The samples were stored in said incubator for 90 days to simulate the situation that they were stored at room temperature for 3 years.

Each group of samples was placed in an environment keeping the temperature at 40° C. to 50° C. and a humidity of 40% to 50%, and the samples were opened by cutting after the specific days (i.e. 30 days, 60 days and 90 days). The Hair Dye I or the Hair Dye II filled therein was poured out and then the samples were respectively washed and followed by airing; finally, the samples were observed by naked eyes to ascertain whether the inner side of the sample (that is, the sealing layer of the packaging material for the hair dye) was peeled off or eroded, and observation results were recorded in Table 2.

When the peeling or erosion phenomenon of the inner side of the sample was not observed, it was determined as passing the stability test, which was indicated as “O” in Table 2; on the contrary, when the peeling or erosion phenomenon of the inner side of the sample was observed, it was determined that it did not pass the stability test, which was indicated as “X” in Table 2.

TABLE 2
No. of the packaging materials for hair dye of Examples
1 to 4, No. of the hair dyes, storage days in the
incubator and the results of the stability test

| No. of | | | | | | |
|---|---|---|---|---|---|---|
| Packaging | Hair Dye I | | | Hair Dye II | | |
| Material for | 30 | 60 | 90 | 30 | 60 | 90 |
| hair dye | Days | Days | Days | Days | Days | Days |
| LA | O | X | X | O | O | O |
| LB | X | X | X | O | O | O |
| LC | O | O | O | X | X | X |
| LD | O | O | O | O | X | X |

### Discussion on the Experimental Results

In Table 1, all of the results of the stability test show that when the packaging material for hair dye of Examples 1 to 4 comprises the specific layers and the specific stacking order thereof, the package bags produced therefrom can have good stability at room temperature; that is, the package bags produced therefrom can have good corrosion resistance at room temperature. Accordingly, the printed layer disposed on the inner side of the protective layer can maintain intact and avoid being eroded or stained by the hair dye. In addition, the results also illustrate that the package bags produced therefrom are suitable to package the hair dyes with different pH values.

From the results of the stability test in Table 2, since the LA and LB accommodating Hair Dye II can pass the stability test of 90 days in the incubator, it shows that the LA and LB are especially suitable to package an acidic hair dye. On the other hand, since the LC and LD accommodated Hair Dye I can pass the stability test of 90 days in the incubator, it shows that the LC and LD are especially suitable to package an alkaline hair dye.

Further, since the LA and LD in Table 2 can pass the stability test of 30 days in the incubator both in the case of filling with the Hair Dye I and Hair Dye II at a higher temperature, it can demonstrate that when the packaging material for hair dye sequentially includes a PET film, a printed layer, a PET film with an aluminum-plated layer thereon and a LLDPE film or when the packaging material for hair dye sequentially includes a PET film, a printed layer, an aluminum foil, a PA film and a CPP film, the packaging material for hair dye can have better stability.

Even though numerous characteristics and advantages of the instant disclosure have been set forth in the foregoing description, together with details of the structure and features of the disclosure, the disclosure is illustrative only. Changes may be made in the details, especially in matters of shape, size, and arrangement of parts within the principles of the disclosure to the full extent indicated by the broad general meaning of the terms in which the appended claims are expressed.

What is claimed is:

1. A packaging material for hair dye comprising:
a protective layer, a light-shielding layer and a sealing layer;
wherein the protective layer has an outer side and an inner side opposite to the outer side, and a printed layer is laminated on the inner side of the protective layer; the light-shielding layer is disposed between the inner side of the protective layer and the sealing layer;
wherein the sealing layer has a single-layer structure or a multilayer structure;
when the sealing layer has the single-layer structure, a material of the sealing layer comprises a polyester, a polyamide, a polyethylene or a polypropylene;
when the sealing layer has the multilayer structure, the multilayer structure has multiple sublayers, and the multiple sublayers are each independently made by a material selected from the group consisting of: a polyester, a polyamide, a polyethylene, a polypropylene and any combination thereof, and the materials of the sublayers are different from each other.

2. The packaging material for hair dye as claimed in claim 1, wherein a material of the protective layer comprises a polyester.

3. The packaging material for hair dye as claimed in claim 2, wherein the protective layer has an average thickness ranging from 6 μm to 24 μm.

4. The packaging material for hair dye as claimed in claim 1, wherein the light-shielding layer comprises a metal foil or a polyethylene terephthalate layer with a metal-plated layer thereon.

5. The packaging material for hair dye as claimed in claim 4, wherein the light-shielding layer has an average thickness ranging from 4 μm to 15 μm.

6. The packaging material for hair dye as claimed in claim 1, wherein the sealing layer has the single-layer structure; the sealing layer has an average thickness ranging from 60 μm to 80 μm.

7. The packaging material for hair dye as claimed in claim 1, wherein the sealing layer has the multilayer structure; the multilayer structure comprises a first sublayer and a second sublayer; wherein the first sublayer has an average thickness ranging from 10 μm to 20 μm, and the second sublayer has an average thickness ranging from 20 μm to 65 μm.

8. The packaging material for hair dye as claimed in claim 3, wherein the sealing layer has the multilayer structure; the multilayer structure comprises a first sublayer and a second sublayer; wherein the first sublayer has an average thickness ranging from 10 μm to 20 μm, and the second sublayer has an average thickness ranging from 20 μm to 65 μm.

9. The packaging material for hair dye as claimed in claim 5, wherein the sealing layer has the multilayer structure; the multilayer structure has a first sublayer and a second sublayer; wherein the first sublayer has an average thickness ranging from 10 μm to 20 μm, and the second sublayer has an average thickness ranging from 20 μm to 65 μm.

10. A package bag produced from the packaging material for hair dye as claimed in claim 1.

11. The package bag as claimed in claim 10, wherein the package bag has one storage chamber.

12. The package bag as claimed in claim 10, wherein the package bag has two storage chambers; the two storage chambers are separated by a partition element.

13. The package bag as claimed in claim 12, wherein the partition element is parallel to bilateral sides of the package bag, and the two storage chambers each have a respective opening, the two openings being adjacent to each other.

14. The package bag as claimed in claim 12, wherein the partition element is sandwiched in the package bag, and the two storage chambers are set front and rear.

15. A package bag produced from the packaging material for hair dye as claimed in claim 7.

16. The package bag as claimed in claim 15, wherein the package bag has one storage chamber.

17. The package bag as claimed in claim 15, wherein the package bag has two storage chambers; the two storage chambers are separated by a partition element.

18. The package bag as claimed in claim 17, wherein the partition element is parallel to bilateral sides of the package bag, and the two storage chambers each have a respective opening, the two openings being adjacent to each other.

19. The package bag as claimed in claim 17, wherein the partition element is sandwiched in the package bag, and the two storage chambers are set front and rear.
